(19) United States
(12) Patent Application Publication
(10) Pub. No.: US 2008/0056552 A1
(43) Pub. Date: Mar. 6, 2008

(54) Method of determining body orientations in space on the basis of two X-ray records

(76) Inventor: Otto Muller, Burladingen (DE)

Correspondence Address: KEVIN J. MCNEELY, ESQ., 5335 WISCONSON AVENUE, NW, SUITE 440, WASHINGTON, DC, 20015, US

(21) Appl. No.: 11/852,794

(22) Filed: Sep. 10, 2007

Related U.S. Application Data
(63) Continuation of application No. PCT/EP2006/002287, filed on Mar. 13, 2006.

(30) Foreign Application Priority Data
Mar. 11, 2005 (DE) DE102005012708.8

(51) Int. Cl. G06K 9/00

(52) U.S. Cl. 382/132

(57) ABSTRACT

A method for determination of the inclination angle and the anteversion angle of an acetabulum of a patient in an anatomical reference system whose orientation is determined by the pelvic bone of the patient, taking account of any pelvis tilt, the method comprising the following steps: a first image of the pelvic bone is provided, wherein the first image shows a frontal plane including the pelvic bone; a first inclination angle of the acetabulum is determined using the first image; a pelvis rotation angle is determined, which indicates the rotation angle of the pelvic bone about the normal to the frontal plane relative to an optimum patient location position; a second image of the pelvic bone is provided, wherein the plane of the second image is rotated by an image rotation angle relative to the frontal plane about a common section line of the two planes, preferably about the body longitudinal axis of the patient; a second inclination angle of the acetabulum is determined using the second image; a pelvis tilt angle is determined, which represents a rotation of the frontal plane of the first image relative to an anterior-pelvic plane in the optimum patient location position; a linear equation system is set up having at least two linear equations as a function of the previously determined angles; the normal vector no is expressed in polar coordinates of the anatomical reference system; the at least two linear equations are solved for the azimuth and polar angle of the normal vector no in order to determine the inclination and the anteversion in this way.

### RELATED APPLICATIONS

This is a continuation application of co-pending International Patent Application PCT/EP 2006/002287 (published as WO 2006/094833) which claims priority of the German Application DE 10 2005 012 708.8 filed on Mar. 11, 2005 which is fully incorporated herewith by reference.

### BACKGROUND OF THE INVENTION

Correct orientation of the acetabulum is an important bio-mechanical precondition for long-term success of hip endoprosthesis. The spatial orientation of the acetabulum is (clinically) defined by two angle quantities, to be precise by the inclination and the anteversion.

FIG. 1 illustrates a part of the human skeleton in highly schematic form, essentially showing only the area of a pelvis 10 on a so-called frontal plane and an aprior-posterior pelvis overview (a.p.-pelvis overview).

FIG. 1 shows schematically, a pelvic bone 12 which has a left acetabulum 14a and a right acetabulum 14b. Acetabular bones 16a and 16b with corresponding acetabular heads 18a and 18b (spherical in an idealized form) are mounted in the acetabula 14a and 14b, which are illustrated in an idealized form as hemispheres. The spinal column is designated by the reference numeral 20. The continuation of the spinal column 20 represents the longitudinal axis 22 of the body, which is illustrated in FIG. 1 by a dashed-dotted line.

The so-called sagittal plane extends along the longitudinal axis 22 of the body and perpendicular to the plane of the drawing of FIG. 1. The plane of the drawing in this case corresponds to the frontal plane or coronal plane. The so-called transverse plane extends perpendicular to the sagittal plane and to the frontal plane. The frontal plane generally corresponds to a plan view of a patient from the front. The (actual) left and right hip of the patient can therefore be seen on the right and left, respectively, in the frontal plane.

The inclination represents the value of the abduction of the acetabulum 18. The abduction is to be understood as the angle between the acetabulum 14 and the axis 22 of the body in the frontal plane.

The orientation of the acetabulum 14 is also indicated by an angle for the so-called anteversion, which represents a value for the rotation of the acetabulum about an axis in the frontal plane. This rotation is indicated by an arrow 24 in FIG. 1. In order to allow this rotation to be illustrated better, the acetabulum 14a arranged on the left in FIG. 1 is illustrated in perspective form, so that, in contrast to the acetabulum 14b that is illustrated in two dimensions, an opening surface 26a of the acetabulum 14a can be seen.

### RELATED PRIOR ART

Values of 45±10 degrees for inclination and 15±10 degrees for anteversion have been found to be advantageous. These angle ranges, with respect to the body-specific (anatomical) reference system, are desirable for hip endoprostheses in hip operations. Both variables represent angle informations which mathematically characterize the alignment of the acetabular plane 26 with respect to the anatomical reference planes (frontal plane, sagittal plane, transverse plane). However, these angles can be indicated not only with respect to an anatomical reference system but also with respect to an external reference system, such as an X-ray appliance or an operation reference system. Different definitions for the inclination and the anteversion are quoted in the article “The Definition and Measurement of Acetabular Orientation” by D. W. Murray in “THE JOURNAL OF BONE AND JOINT SURGERY”, page 228 to 232, vol. 75-B, no. 2, March 1993. The nomenclature used there and the various definitions will also be used in the following text here.

The inclination and the anteverson therefore represent angle quantities which mathematically characterize the alignment of the acetabular plane with respect to the anatomical reference planes (sagittal plane, frontal plane, etc, see Murray). In clinical practice, the aim is to determine both variables from conventional radiographs.

These two angle quantities are important measurement quantities for orthopedic surgeons for both preoperative operation planning and post-operative assessment of the operation success, since the values of the inclination should preferably be in the region of 45 degrees±10 degrees, and those of the anteversion should be in the region of 15 degrees±10 degrees.

The use of conventional X-ray techniques to determine these angle quantities results in two major disadvantages which make exact determination of the inclination and anteversion more difficult, or impossible.

A first disadvantage is that the angles to be determined refer to geometric lines in space, in particular to geometric structures of the pelvis. In clinical practice, the aim is to determine these angles from conventional radiographs. However, the angles can be determined only inadequately from these images since the angles in space are generally imaged “in a distorted form” on flat projection surfaces. One reason for this distortion is that the projection plane, i.e. the plane of a radiograph, does not normally correspond to the anatomical plane in which the angles are defined.

A second disadvantage is that mathematical and technical definition of the inclination and anteversion makes sense only if these details refer to a pelvis-internal reference system, i.e. to an anatomical coordinate system. The anatomical pelvis coordinate system is defined on the basis of three significant points on the pelvic bone, which form a so-called anterior-pelvic plane, as will be described in even more detail in conjunction with FIG. 3.

Conventional evaluation methods, such as that of Sven Johansson or the Visser technique (Johansson, S., “Zur Technik der Osteosynthese der Fratt. coli femoris, [On the technique of osteosynthesis of Fratt. cori femoris] Zbl. Chir., 59, 2019-2022, 1932; Visser, J. D. et al., 1981, A New Method for Measuring Angles After Total Hip Arthroplasty, J. Bone Joint Surg. Br., 63B, 556-559), are not oriented using the anatomical reference system but using a coordinate system which is defined by the direction of the X-ray beam and the orientation of the projection plane of the X-ray image with respect to it. The standard image for assessing a pelvis is the so-called anterior-posterior pelvis overview. The X-ray beam in this case impinges on the patient frontally. The X-ray projection image is then oriented parallel to the frontal plane of the patient.

A defined patient position is used in an attempt to overcome the first of the described disadvantages, and to keep sources of error thereof as small as possible. The second of the described disadvantages is, however, system immanent, since the orientation of the anterior-pelvic plane is not taken into account in the methods mentioned above.

The Sven-Johansson technique requires two X-ray images, between which, however, the position of the patient must be changed. This means that the orientation of the patient's pelvis is changed in space between the images. The Sven-Johansson technique requires an a.p.-pelvis overview as well as an axiol-lateral X-ray image, with the X-ray beam being rotated by 45° with respect to the longitudinal axis in the frontal plane, and with the other leg being raised. This places very specific requirements on the patient positioning, which can rarely be met in clinical practice.

The Visser-technique analyzes the major axes of a projected acetabular edge using a single X-ray image (specifically the a.p.-pelvis overview) and in this case implicitly requires that the anterior-pelvic plane is oriented parallel to the projection plane of the X-ray image, i.e. to the frontal plane and the X-ray film. In this case, the anteversion of an implanted metal acetabulum is determined from the major axis ratio of the acetabular edge projected as an ellipse.

Neither method takes account of any tilting of the anterior-pelvic plane with respect to the frontal plane. However, it is possible to verify by calculation that tilting of the anterior-pelvic plane with respect to the frontal plane, which necessarily occurs when X-ray images are being created, can lead to errors of up to ±10 degrees in the determination of the inclination and/or anteversion.

It would admittedly be possible, in principle, to determine the inclination and the anteversion using layer images by means of computer tomography (CT). However, this option is not used in practice since CT records are associated with considerable radiation loads on the patient, and also with higher costs.

In addition, it is possible to use computer-aided navigation systems during the operation, which have been developed in order to assist and to guide the surgeon while implanting the acetabulum. Irrespective of whether these navigation systems operate using CT images or a technique without CT, anatomical marking points on the pelvis must be defined intraoperatively in order to define the anatomical coordinate system. In a situation like this, the orientation of the acetabulum is adapted using a so-called acetabular mill, which is guided by means of a guidance system with respect to the anatomical coordinate system obtained in this way.

Irrespective of the accuracy that can be achieved using these navigation systems, the exact alignment of the acetabulum is nevertheless highly dependent on how exactly the markings are positioned with respect to the pelvic bone. It is therefore also desirable to additionally determine the alignment of the acetabulum post-operatively. However, none of the conventional X-ray methods take account of the anatomical coordinate system of the pelvis. Measurement errors in the order of magnitude of 10 degrees have been found in computer simulations for the anteversion, although this depends on the extent of pelvis inclination, which may vary in a range of approximately 20 degrees with respect to the reclination and 10 degrees with respect to the inclination.

### SUMMARY OF THE INVENTION

One object of the present invention therefore is to provide an improved method for accurate determination of the inclination and anteversion, in particular in relation to anatomical reference planes, with an angle accuracy of better than ±5 degrees being desirable.

This object is achieved by a method which comprises the following steps: a first image of the pelvic bone is provided, wherein the first image shows a frontal plane including the pelvic bone; a first inclination angle of the acetabulum is determined using the first image; a pelvis rotation angle is determined, which indicates the rotation angle of the pelvic bone about the normal to the frontal plane relative to an optimum patient location position; a second image of the pelvic bone is provided, wherein the plane of the second image is rotated by an image rotation angle relative to the frontal plane about a common section line of the two planes, preferably about the body longitudinal axis of the patient; a second inclination angle of the acetabulum is determined using the second image; a pelvis tilt angle is determined, which represents rotation of the frontal plane of the first image relative to a pelvis input plane in the optimum patient location position; a linear equation system is set up having at least two linear equations as a function of the previously determined angles; the normal vector no is expressed in polar coordinates of the anatomical reference system; the at least two linear equations are solved for the azimuth and polar angle of the normal vector no in order to determine the inclination and the anteversion in this way.

The method according to the invention has the advantage that only two images of the pelvic bone of the patient need to be produced, thus representing a time saving in comparison to CT. Furthermore, the patients are subject to a lower radiation load, if the images are provided on the basis of X-ray beams.

Furthermore, the method according to the present invention takes account of pelvis tilting, thus making it possible to make more accurate statements about the orientation of the acetabulum, to be precise the inclination and anteversion, in the anatomical reference system.

These more accurate statements are of major importance both pre-operatively and post-operatively. More accurate statements can be made about the orientation of the original acetabulum for the pre-operative planning of a hip operation. More accurate statements can therefore be made about the success or failure of an operation, for post-operative checking.

According to one preferred embodiment of the invention, the equation system corresponds to a linear image A which in turn maps the normal vector to the acetabulum opening plane onto the zero vector of the anatomical reference system.

It is also advantageous if as an alternative to solving of the at least two linear equations for the azimuth and polar angle of the normal vector, the azimuth and the polar angle of the normal vector are determined by determining the eigen vector of the image A for the eigen value of zero.

It is particularly advantageous if a first equation of the linear equations represents a rotation of the acetabulum by the pelvis tilt angle and by the pelvis rotation angle in order to represent the first inclination angle RI2, and a second equation of the linear equations represents a further rotation of the first equation by the image rotation angle in order to represent the second inclination angle RI3.

An optimum patient location position is defined in that the pelvis input plane is oriented parallel to the frontal plane, and in that a connecting line between the acetabulum center points is oriented parallel to one of the unit vectors which spans the frontal plane, wherein the other unit vector is oriented parallel to the body longitudinal axis of the patient.

This measure makes it easier to determine the angles from the images, wherein the imaging system is rotated about the body longitudinal axis. The pelvis rotation angle δ can therefore also be zero.

According to a further preferred embodiment, the anatomical reference system is defined by the pelvis input plane which is defined by the spinae at the front iliac crest and the symphysis of the pelvic bone.

It is also advantageous if the imaging system is rotated about the body longitudinal axis of the patient in order to produce the second image.

The first and second inclination angles are each preferably determined by means of a major axis of the acetabular edge or a corresponding normal vector which is in each case perpendicular to an opening surface of the relevant acetabulum as being imaged in the first image and the second image, respectively.

In this case, the respective normal vector and its projection can be determined in that the acetabulum is approximated by an open hemisphere, wherein an opening edge of the respective hemisphere is approximated by an ellipse, major axes of which are determined, with respect to which the respective (imaginary) normal vector is oriented orthogonally.

The first and second inclination angles can be determined geometrically on the basis of the respective angle between the normal vector and the horizontal of the frontal plane.

In addition, the origin of the frontal plane can be located at the center point of the acetabulum.

According to a further preferred embodiment, the images are provided in the terms of data sets.

This has the advantage that the images are stored for example in digital form after creation in order to be passed subsequently to appropriate planning or checking software.

According to a further embodiment, the images are provided by means of X-ray images or NMR.

The pelvis rotation angle δ can be determined geometrically as the angle between a horizontal of the frontal plane and an (imaginary) connecting line between the acetabulum center points.

The pelvis tilt angle α is preferably determined using a pelvis balance.

It is also advantageous if the images are provided using an imaging system which has a radiation source and a detection device, which are arranged rigidly with respect to each other and, in particular, can be rotated about the axis of the body of the patient. The imaging system may be a so-called C-arc.

It is clear that the features mentioned above and those which are still to be explained in the following can be used not only in the respectively stated combination but also in other combinations or on their own without departing from the scope of the present invention.

Exemplary embodiments of the invention will be explained in more detail in the following description and are illustrated in the drawing, in which:

### BRIEF DESCRIPTION OF THE DRAWINGS

FIG. 1 shows a schematic plan view of a pelvic bone, and a partially illustrated spinal column, as well as partially illustrated femurs.

FIG. 2 shows a normal vector of an acetabulum in an anatomical reference system.

FIG. 3 shows an anterior-pelvic plane on the basis of a perspective illustration of a pelvic bone.

FIG. 4 shows a part of a first image of an acetabulum, from which the normal vector can be determined.

FIGS. 5a and 5b show one example of the arrangement of a patient relative to an imaging system.

FIG. 6 shows one example of how two images can be obtained, as required to carry out the method according to the invention.

### DESCRIPTION OF PREFERRED EMBODIMENTS

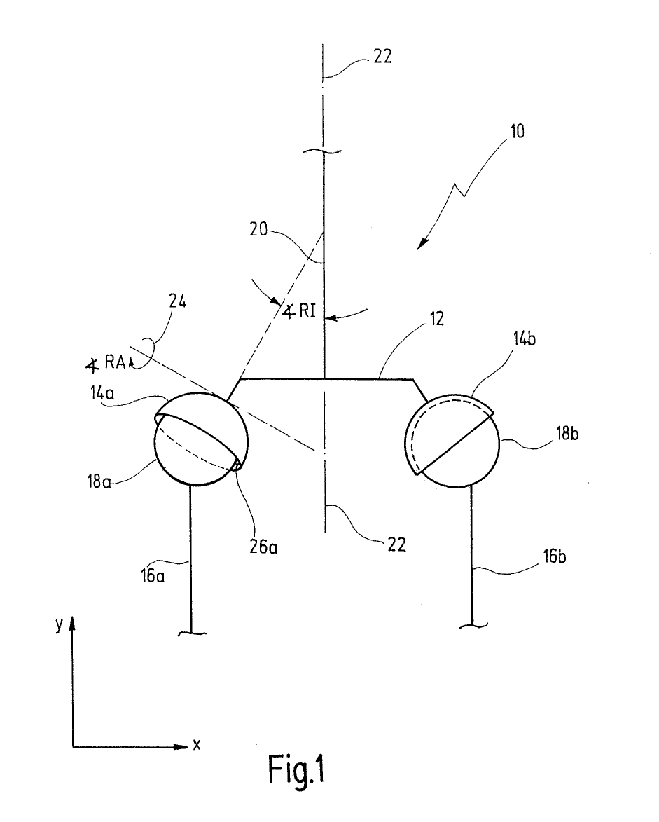

Mathematically, the orientation of an acetabulum can be represented by a normal vector \vec{n} of the acetabulum opening plane with respect to an anatomical pelvis coordinate system (see FIG. 1). The anatomical pelvis coordinate system is preferably defined with the aid of a anterior-pelvic plane, which is in turn defined by two spinae of the pelvis (“spines iliac anterior superior, SIAS”) and the symphysis of the pelvic bone. This plane is defined by the x and y unit vectors of a Cartesian coordinate system. The z unit vector of this system is perpendicular to this plane, and emerges from it. The inclination and anteversion of the acetabulum can thus be expressed in polar coordinates, in the form of the azimuth and the polar angle.

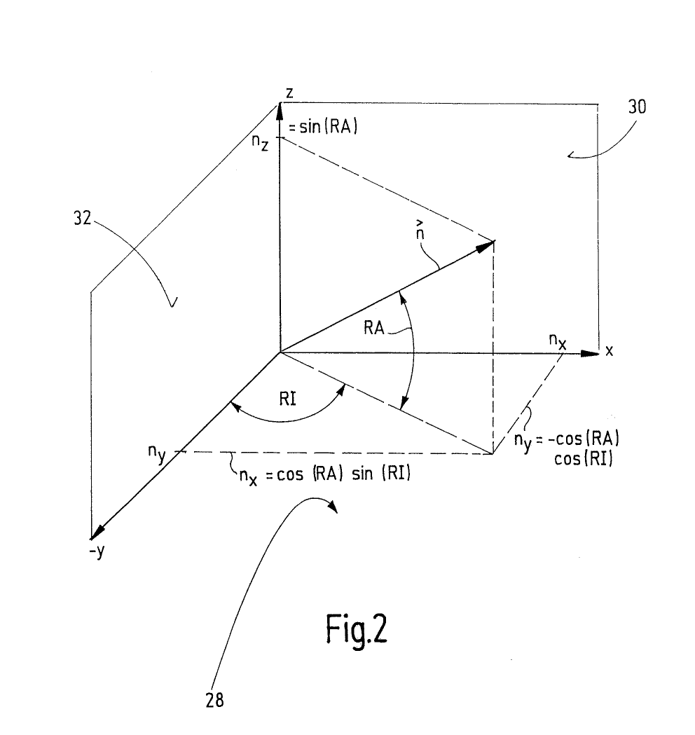

FIG. 2 shows an example of the orientation of any given vector \vec{n} in a polar coordinate system.

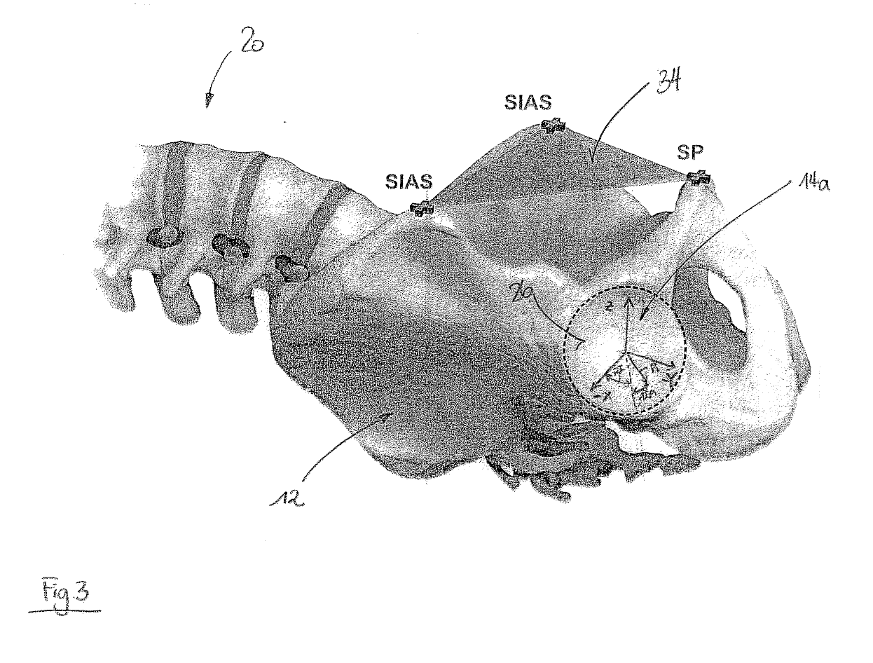

The normal vector \vec{n} is perpendicular to the acetabular opening surface 26 (see FIG. 3). The acetabulum itself is not shown in FIG. 2, in order to maintain the clarity of FIG. 2.

The origin of the Cartesian coordinate system in FIG. 2 corresponds to the center point of the acetabulum opening surface. The example in FIG. 2 schematically illustrates the normal vector \vec{n} of the right-hand acetabulum 14b in FIG. 1. If FIG. 2 is viewed from above, i.e. from the z direction, this results in the view in FIG. 1, although only the right-hand hip and its normal vector are illustrated in FIG. 2.

The unit vectors in the Cartesian coordinate system shown in FIG. 2 cover planes which are defined as follows. The unit vectors x and y define the frontal or coronal plane 28. In clinical X-ray images, the frontal plane 28 is parallel to the plane of the X-ray film in the a.p.-pelvis overview image. In the a.p.-pelvis overview, the patient (not illustrated in FIG. 2) is aligned with her/his body longitudinal axis 22 (see FIG. 1) along the y axis in FIG. 2. The X-ray beam impinges perpendicularly on the frontal plane 28, coming from the z direction.

The unit vectors in the x direction and z direction define a so-called transverse plane 30.

The unit vectors in the y direction and z direction define a so-called sagittal plane.

The individual components nₓ, n_{y} and n_{z} of the normal vector \vec{n} can be expressed as follows in polar coordinates, on the basis of Murray's radiological annotations in an anatomical coordinate system, whose orientation is defined by the so-called anterior-pelvic plane (APP concept):

$$\vec{n} = ( \begin{matrix}{n}_{x} \\ {n}_{y} \\ {n}_{z}\end{matrix} ) = ( \begin{matrix}cos ( RA ) sin ( RI ) \\ - cos ( RA ) cos ( RI ) \\ sin ( RA )\end{matrix} ) \qquad ( eq . 1 )$$

where RA denotes the radiological anteversion angle and RI the radiological inclination angle. For the sake of simplicity, the anteversion angle and the inclination angle will also be referred to in the following text simply as anteversion and inclination.

The values for the inclination RI and the anteversion RA can be calculated from the components of the normal vector as follows:

$$tan ( RI ) = \frac{{n}_{x}}{- {n}_{y}} and sin ( RA ) = {n}_{z 1} \qquad ( eq . 2 a and eq . 2 b )$$

As already mentioned initially, the inclination and the anteversion are intended to be determined correctly, to be precise using the patient's anatomical coordinate system. The anterior-pelvic plane, which has already been mentioned above, is illustrated in FIG. 3, and is designated by the reference numeral 34.

FIG. 3 shows a schematic perspective view of a pelvic bone 12 and of a piece of a spinal column 20 (see also FIG. 1). Only the right-hand acetabulum 14a can be seen in the view in FIG. 3. The anterior-pelvic plane 34 is used as a reference plane in the anatomical reference system (APP concept).

Furthermore, an acetabulum opening surface 26 is surrounded by a dashed line in FIG. 3. The center point of this surface 26 is used as the origin of a Cartesian coordinate system in which the normal vector \vec{n} of the acetabulum 14a is defined. The xy plane of this Cartesian coordinate system is oriented parallel to the anterior-pelvic plane 34. The anterior-pelvic plane 34 is formed by the two spinae (spinae iliaca anterior superior, SIAS) at the front iliac crest and the symphysis.

The anteversion RA corresponds to the angle between the acetabular normal vector \vec{n} and the xy plane (polar angle). The inclination RI corresponds to the rotation angle of the normal vector about the z axis (azimuth angle).

When the patient is in an ideal position, the anterior-pelvic plane 34 is oriented parallel to a plane of a table on which the patient is lying. A table such as this is normally part of an X-ray apparatus, in which the X-ray source radiates at right angles to the table surface and image-detecting means, such as an X-ray film or an X-ray detector, is arranged underneath the table surface and parallel to it. In this case, the pelvis tilt is then 0°. The pelvis tilt or its angle expresses a rotation about the x axis in the Cartesian coordinate system (for the acetabulum). However, in clinical practice, the patient is generally not located in the optimum patient position.

The x axis of the Cartesian coordinate system shown in FIG. 3 is defined by an (imaginary) connecting line between the center points of the acetabulum opening surfaces 26.

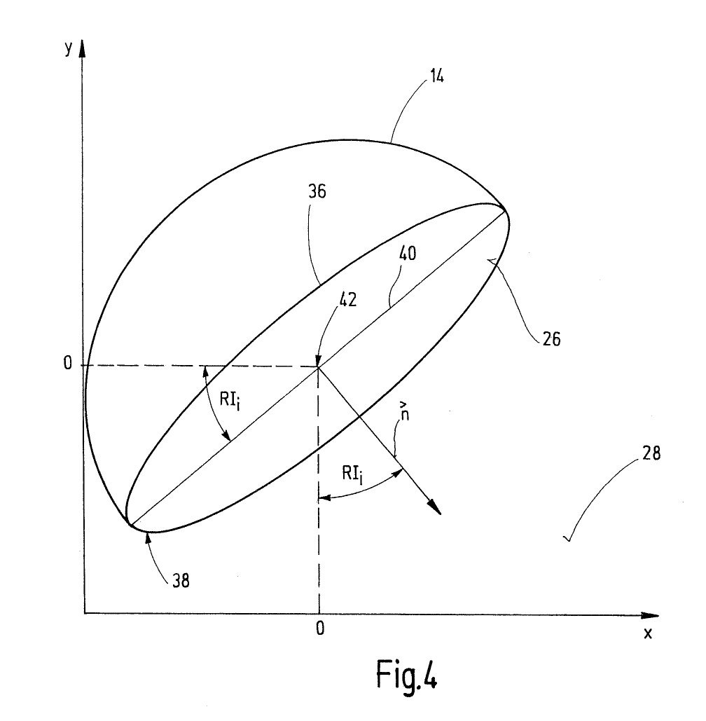

The acetabulum 14 can be idealized by a hemisphere, as illustrated in FIG. 4.

FIG. 4 shows a partial detail from a schematic X-ray image, in which only a left-hand acetabulum 14 is illustrated. The structure illustrated by way of example in FIG. 4 is obtained, for example, by means of the a.p.-pelvis overview image as mentioned above, with the plane of the drawing of FIG. 4 corresponding to the plane of an X-ray film which is used for such an image. This plane corresponds to the frontal plane.

If the acetabulum 14 is idealized by a hemisphere, the orientation of the acetabulum 14 can now be obtained from the corresponding X-ray image on the basis of the opening edge 36 of the acetabular opening surface 26.

The opening edge 36 (of the idealized hemispherical acetabulum 14) is for this purpose approximated by an ellipse. The opening edge 36 can be identified in the X-ray image. The normal vector \vec{n} of the acetabulum 14 or, to be more precise, the projection of the normal vector, can be determined by means of a major axis 40 of the ellipse 38. The maximum and minimum distances between the acetabular opening edge 36 and a coordinate origin 42 are determined in order to define the major axis 40. The coordinate origin 42 corresponds to the center point of the acetabular opening surface 26, as already explained above. This allows the major axis 40 to be determined (visually, by identification software, etc.) from the maximum distances from the coordinate origin 42.

The normal vector \vec{n} (which is imaginary, because it is not included in the X-ray image) can be determined with the aid of the major axis 42. The so determined normal vector \vec{n} of FIG. 4 corresponds to the normal vector \vec{n} of the acetabulum 14 in the radiological reference system (of the X-ray image). The x axis in FIG. 4 is in this case chosen as far as possible such that it runs parallel to the imaginary connecting line (not illustrated) between the acetabular center points, as already explained above.

The inclination angle RIᵢ of an i-th X-ray image can thus be obtained numerically and geometrically from the angle between the major axis 40 and a horizontal.

Two images of the pelvic bone 12 are produced using the method according to the invention. The images can be generated using X-ray techniques, NMR techniques, etc.

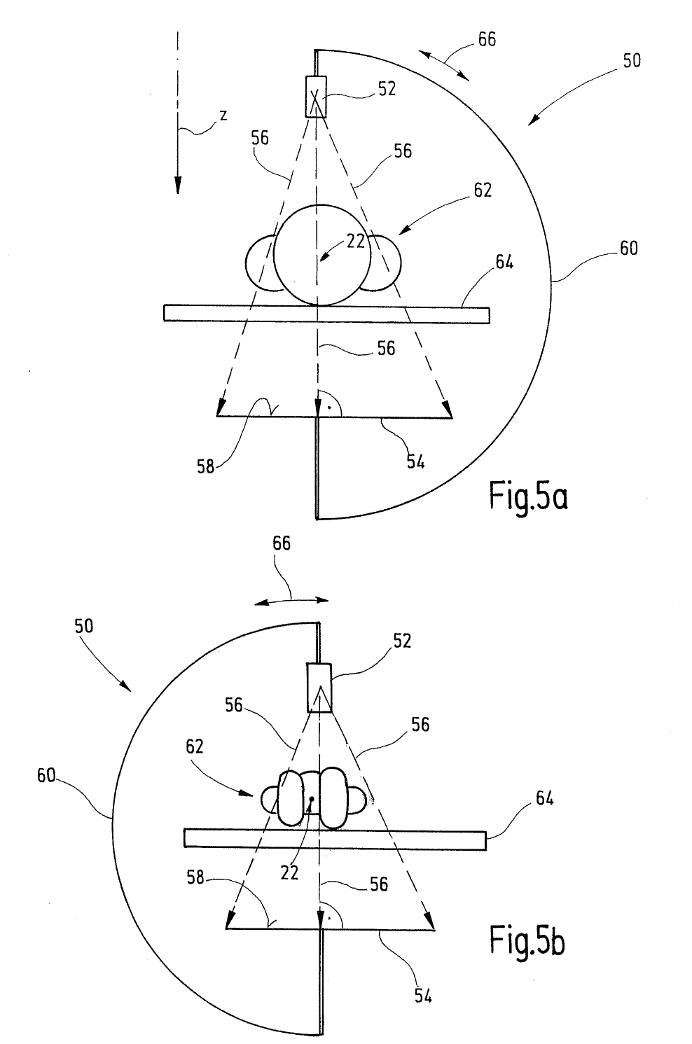

FIGS. 5a and 5b each show an X-ray appliance 50 which has an X-ray source 52 as well as X-ray detection means 54, such as an X-ray film, detecting X-ray beams 56 emitted from the X-ray source. The X-ray source 52 in this case irradiates a detection area 58 of the X-ray detection means 54 at right angles. The X-ray source 52 and the X-ray detection means 54 are connected to one another, for example by means of a C-shaped frame 60.

A patient 62 lies on a preferably horizontally aligned table 54 with the surface of the table likewise being oriented perpendicular to the X-ray source 52, and therefore parallel to the surface 58 of the X-ray detection means 54. The X-ray source 52 and the X-ray detection means 54 can preferably be rotated about the body longitudinal axis 22 of the patient 62 by means of the C-shaped frame 60, as is indicated by double-headed arrows in FIGS. 5a and 5b.

FIG. 5a shows the X-ray appliance 50, wherein one looks at the head of the patient 62, and FIG. 5b shows the X-ray appliance 50 from the opposite direction, i.e. looking at the feet of the patient 62.

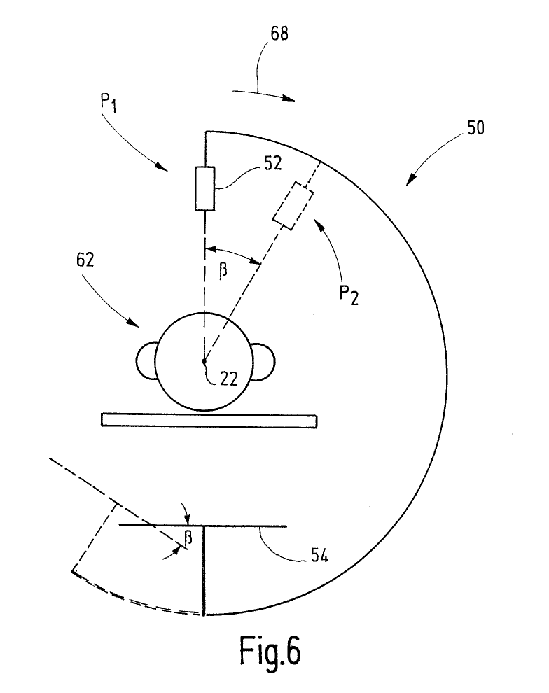

FIG. 6 shows two positions P1 and P2 of the X-ray appliance 50, in each of which an X-ray image is taken. The position P2 of the X-ray appliance 50 is represented by a dashed line.

The a.p. X-ray image is taken in the position P1. A second X-ray image is taken, or a second radiograph is produced, in the position P2, with the X-ray appliance 50 being rotated by any desired image rotation angle β, preferably by about 30° to 50°, and in particular by 40°, in the direction of the arrow 68 around the body longitudinal axis 22 of the patient 62. It is to be noted that the patient 62 does not need to be moved in order to produce these two images. The position and alignment of the X-ray source 52 with respect to the X-ray detection means 54 also remain unchanged.

Using two such X-ray images, the inclination can in each case be determined (geometrically) in the manner described above, either manually or by usage of computers. The inclination angles can in each case be determined (in the radiological reference system of the X-ray images) from the two X-ray images provided in this way. Furthermore, the image rotation angle β is known.

In addition, a so-called pelvis-rotation angle δ can be determined from the X-ray images.

The pelvis-rotation angle δ represents the angle between the (imaginary) connecting line between the two acetabulum center points, contained in the X-ray image, and a horizontal of the X-ray image (or the frontal plane). Clinically, this reference line is normally determined from the lowest points of the edges of the two blades of the pubic bone, in order to determine the angle δ. The pelvis rotation angle δ therefore means nothing more than a rotation of the pelvis from the optimum patient position as described above about the z axis (see FIG. 1, in which the z axis projects vertically from the plane of the figure).

Furthermore, a pelvis-tilt angle α is determined, for example using a pelvis balance. The pelvis-tilt angle α represents the tilt of the anterior-pelvic plane 34 (see FIG. 3) about the x axis. In order to orient the frontal plane 28 parallel to the anterior-pelvic plane 34, the frontal plane 28 is rotated by α about the x axis, which corresponds to the connecting line between the acetabulum center points 42.

The pelvis-tilt angle α can be determined, for example, during the process of producing the two images, as is illustrated in FIG. 6. For this purpose, a pelvis balance (not illustrated) is placed on the two spinae and on the symphysis of the patient 62. The pelvis balance contains an indication from which the pelvis-tilt angle α can be read.

Thus, five angles are known. The inclination angle RIᵢ (i=1, 2) of the first and second images, the image rotation angle β, the pelvis rotation angle δ and the pelvis-tilt angle α.

The anatomical inclination and the anatomical anteversion, i.e. the inclination and the anteversion, can be determined in the anatomical reference system using these angles, as will be explained in the following text.

Equation 2a indicates the radiological inclination RI, which can in turn be measured from the frontal plane 28 of a projected line of the normal vector \vec{n} from an X-ray image.

As already mentioned, the pelvis 10 is normally tilted about the hip rotation centers with respect to the frontal plane 28, so that the anterior-pelvic plane 34 is not parallel to the frontal plane 28. Mathematically, this corresponds to a (planar) rotation about the x axis, to be precise by the pelvis rotation angle α. An undisturbed normal vector n₀ of an acetabulum is therefore rotated to the normal vector n₁ on the basis of the following equation:

$$\begin{matrix}{\vec{n}}_{0} \to {\vec{n}}_{1} = {A}_{x} \cdot {\vec{n}}_{0} \\ = ( \begin{matrix}1 & 0 & 0 \\ 0 & cos ( α ) & - sin ( α ) \\ 0 & sin ( α ) & cos ( α )\end{matrix} ) ( \begin{matrix}{n}_{x} \\ {n}_{y} \\ {n}_{z}\end{matrix} ) \\ = ( \begin{matrix}{n}_{x} \\ {n}_{y} cos ( α ) - {n}_{z} sin ( α ) \\ {n}_{y} sin ( α ) + {n}_{z} cos ( α )\end{matrix} )\end{matrix} \qquad ( eq . 3 )$$

A disturbed value for the inclination angle RI1 can be calculated from the components of the rotated normal vector \vec{n₁}:

$$tan ( RI 1 ) = \frac{{n}_{1 x}}{{n}_{1 y}} = \frac{{n}_{x}}{- ( {n}_{y} cos ( α ) - {n}_{z} sin ( α ) )} \qquad ( eq . 4 a )$$

This equation can be rewritten as:

$$\begin{matrix}cot ( RI 1 ) = \frac{1}{tan ( RI 1 )} \\ = \frac{{n}_{y}}{{n}_{z}} cos ( a ) + \frac{- {n}_{z}}{{n}_{x}} sin ( α ) \\ = cot ( RI ) cos ( α ) + tan ( RA ) \frac{1}{sin ( RI )} sin ( α )\end{matrix} \qquad ( eq . 4 b )$$

Since the patient alignment is normally also not ideal with respect to the body longitudinal axis, the pelvis can be rotated not only about the x axis but also about the z axis. The rotation of the pelvis in the frontal plane 28 can therefore be expressed by subsequent rotation about the z plane with the rotation angle δ as follows:

$$\begin{matrix}{\vec{n}}_{1} \to {\vec{n}}_{2} = {A}_{2} \cdot {\vec{n}}_{1} \\ = ( \begin{matrix}cos ( δ ) & - sin ( δ ) & 0 \\ sin ( δ ) & cos ( δ ) & 0 \\ 0 & 0 & 1\end{matrix} ) ( \begin{matrix}{n}_{1 x} \\ {n}_{1 y} \\ {n}_{1 z}\end{matrix} )\end{matrix} \qquad ( eq . 5 a )$$

Taking account of equation 3, this thus results in:

$$( \begin{matrix}{n}_{2 x} \\ {n}_{2 y} \\ {n}_{2 z}\end{matrix} ) = ( \begin{matrix}{n}_{x} cos ( δ ) - ( {n}_{y} cos ( α ) - {n}_{z} sin ( α ) ) sin ( δ ) \\ {n}_{x} sin ( δ ) + ( {n}_{y} cos ( α ) - {n}_{z} sin ( α ) ) cos ( δ ) \\ {n}_{y} sin ( α ) + {n}_{z} cos ( α )\end{matrix} ) \qquad ( eq . 5 b )$$

The value of the (once again) disturbed inclination RI2 can therefore be determined by:

$$\begin{matrix}tan ( RI 2 ) = \frac{{n}_{2 x}}{- {n}_{2 y}} \\ = \frac{{n}_{x} cos ( δ ) - {n}_{y} cos ( α ) - {n}_{z} sin ( α ) ) sin ( δ )}{- ( {n}_{x} sin ( δ ) + {n}_{y} cos ( α ) - {n}_{z} sin ( α ) ) cos ( δ ) )}\end{matrix} \qquad ( eq . 6 )$$

where the inclination RI2 corresponds to the measured inclination angle, or the inclination angle to be measured, of the first image.

Equation 6 provides a linear equation for the components of the undisturbed normal vector n₀.
0=nₓ cos(δ)−(n_{y} cos(α)−n_{z} sin(α)) sin(δ)+tan(RI2)((nₓ sin(δ)+(n_{y} cos(α)−n_{z} sin(α))cos(δ)) (eq. 7)

The second image which, for example, is recorded from the position P2 in FIG. 6, will be used in the following equations in order to make use of the information about the second inclination angle of the second image. When recording the second image, the X-ray appliance is, for example, rotated by the image rotation angle β about the body longitudinal axis 22 of the patient 62.

Mathematically, this additional rotation about the y axis in the frontal plane can be expressed as follows, taking account of equation 5a:

$$\begin{matrix} {\vec{n}}_{2} \to {\vec{n}}_{3} = {A}_{y} \cdot {\vec{n}}_{2} = ( \begin{matrix}cos ( β ) & 0 & sin ( β ) \\ 0 & 1 & 0 \\ - sin ( β ) & 0 & cos ( β )\end{matrix} ) ( \begin{matrix}{n}_{2 x} \\ {n}_{2 y} \\ {n}_{2 z}\end{matrix} ) & ( eq . 8 a ) \\ ( \begin{matrix}{n}_{3 x} \\ {n}_{3 y} \\ {n}_{3 z}\end{matrix} ) = ( \begin{matrix}[ {n}_{x} cos ( δ ) - ( {n}_{y} cos ( α ) - {n}_{z} sin ( α ) ) sin ( δ ) ] cos ( β ) + [ {n}_{y} sin ( α ) + {n}_{z} cos ( α ) ] sin ( β ) \\ {n}_{x} sin ( δ ) + ( {n}_{y} cos ( α ) - {n}_{z} sin ( α ) ) cos ( δ ) \\ - [ {n}_{x} cos ( δ ) - ( {n}_{y} cos ( α ) - {n}_{z} sin ( α ) ) sin ( δ ) ] sin ( β ) + [ {n}_{y} sin ( α ) + {n}_{z} cos ( α ) ] cos ( β )\end{matrix} ) & ( eq . 8 b )\end{matrix}$$

As before, the following equation is obtained for the projected inclination angle RI3, which corresponds to the inclination angle measured in the second image:

$$tan ( RI 3 ) = \frac{\begin{matrix}⌊ {n}_{x} cos ( δ ) - ( {n}_{y} cos ( α ) - {n}_{z} sin ( α ) ) sin ( δ ) ⌋ cos ( δ ) + \\ ⌊ {n}_{y} sin ( α ) + {n}_{z} cos ( α ) ⌋ sin ( β )\end{matrix}}{- ( {n}_{x} sin ( δ ) + ( {n}_{y} cos ( α ) - {n}_{z} sin ( α ) ) cos ( δ ) )} \\ 0 = ⌊ {n}_{x} cos ( δ ) - ( {n}_{y} cos ( α ) - {n}_{z} sin ( α ) ) sin ( δ ) ⌋ cos ( δ ) + ⌊ {n}_{y} sin ( α ) + {n}_{z} cos ( α ) ⌋ sin ( β ) + tan ( RI 3 ) ( {n}_{x} sin ( δ ) + ( {n}_{y} cos ( α ) - {n}_{z} sin ( a ) ) cos ( δ ) ) \qquad ( eq . 9 )$$

Equation 9 likewise represents a linear equation, which includes the unknown components nₓ, n_{y} and n_{z} of the normal vector n₀.

Two equations (equations 7 and 9) are therefore available for the three unknown components of the normal vector. If equation 1 is additionally taken into account now, i.e. the fact that the normal vector can also be represented using polar coordinates, then it can be seen that there are two linear equations with a total of two unknown variables. The unknown variables are the azimuth and polar angle. The azimuth and the polar angle once again correspond to the inclination and the anteversion in the anatomical reference system. These two angles are obtained as follows:

On the basis of equations 7 and 9, a linear equation system can be created by converting equation 7 to equation 7c:
0=nₓ cos(δ)−n_{y} cos(α)sin(δ)+n_{z} sin(α)sin(δ)+nₓ sin(δ)tan(RI2)+n_{y} cos(α)cos(δ)tan(RI2)−n_{z} sin(α)cos(δ)tan(RI2) (eq. A7a)
0=nₓ cos(δ)+nₓ sin(δ)tan(RI2)−n_{y} cos(α)sin(δ)+n_{y} cos(α)cos(δ)tan(RI2)+n_{z} sin(α)sin(δ)−n_{z} sin(α)cos(δ)tan(RI2) (eq. A7b)
0=(cos(δ)+sin(δ)tan(RI2))·nₓ+(−cos(α)sin(δ)+cos(α)cos(δ)tan(RI2))·n_{y}+(sin(α)sin(δ)−sin(α)cos(δ)tan(RI2))·n_{z} (eq. A7c)

In a similar manner, for equation A9

$$\begin{matrix}\begin{matrix}0 = {n}_{x} cos ( δ ) cos ( β ) - {n}_{y} cos ( α ) sin ( δ ) cos ( β ) + \\ {n}_{z} sin ( α ) sin ( δ ) cos ( β ) + {n}_{y} sin ( α ) sin ( β ) + \\ {n}_{2} cos ( α ) sin ( β ) + {n}_{x} sin ( δ ) tan ( R 13 ) + {n}_{y} cos ( α ) cos ( δ ) \\ tan ( R 13 ) - {n}_{z} sin ( α ) cos ( δ ) tan ( R 13 )\end{matrix} & ( eq . A9a ) \\ \begin{matrix}0 = ( cos ( δ ) cos ( β ) + sin ( δ ) tan ( R 13 ) ) \cdot {n}_{x} + ( - cos ( α ) sin ( δ ) \\ cos ( β ) + sin ( α ) sin ( β ) + cos ( α ) cos ( δ ) tan ( R 13 ) ) \cdot \\ {n}_{y} + ( sin ( α ) sin ( δ ) cos ( β ) + cos ( α ) sin ( β ) - \\ sin ( α ) cos ( δ ) tan ( R 13 ) ) \cdot {n}_{z}\end{matrix} & ( eq . A9b )\end{matrix}$$

Equations 7c and 9b represent a system of linear equations for the unknown values of the components nₓ, n_{y} and n_{z} of the normal vector n₀. This equation system can be written as follows:

$$( \begin{matrix}0 \\ 0 \\ 0\end{matrix} ) = ( \begin{matrix}a 11 & a 12 & a 13 \\ a 21 & a 22 & a 23 \\ 0 & 0 & 0\end{matrix} ) ( \begin{matrix}{n}_{x} \\ {n}_{y} \\ {n}_{z}\end{matrix} ) = A \cdot {{n}_{0}}^{->} \qquad ( eq . A10 )$$

The third line in the matrix A has been added arbitrarily, and represents nothing more than the equation 0=0. The first two coefficients in the matrix Aᵢⱼ are, for example:
a11=cos(δ)+sin(δ)tan(RI2)
a12=−cos(α)sin(δ)+cos(δ)cos(δ)tan(RI2)

Equation 10 represents a linear equation system with two equations and three unknowns (nₓ, n_{y}, n_{z}). Apart from the trivial solution (0,0,0)^{T}, an equation such as this has a further solution, specifically a vector which defines the direction of a straight line.

If equation 10 is regarded as a linear mapping, then, apart from the trivial solution vector (0,0,0)^{T}, this results in a vector (nx, ny, nz)^{T} which is mapped onto the zero vector, to be precise with the eigen value of zero.

Since the normal vector of the acetabulum unambiguously characterizes the orientation of the acetabulum, the projection of the normal vector in the frontal plane, and thus the inclination angle, can be determined on the basis of the measurable major axes 40 (see FIG. 4) of the elliptical outline 36. This means that measurement of the major axis results in identical information about the acetabulum alignment to that by projection of the normal vector of the acetabulum.

One exemplary embodiment of the method according to the invention can be summarized as follows: the major axis of the acetabulum of interest is determined from a first normal anterior-posterior X-ray image; furthermore, the orientation of the pelvis (i.e. the angle δ) is determined in the frontal plane, for example on the first image; a second X-ray image is obtained by the X-ray appliance being rotated in a defined manner about the longitudinal axis of the patient, without having to change the patient position; once again, the projected major axis of the acetabulum can be determined on the basis of the second image, and therefore also a second inclination angle; the pelvis inclination α can be determined by means of an additional measurement, for example by means of a pelvis balance. These five angle values are substituted in the equations that have already been mentioned, in order to solve these equations for the inclination and anteversion in the anatomical reference system.

Since all of the measurements are subject to measurement errors, simulation calculations have been carried out which take account of the influence of discrepancies in the angles mentioned above.

The following Table 1

| | Error RA | Error RI |
|---|---|---|
| Parameter | [Degree/Degree] | [Degree/Degree] |
| RI2 | 1.8 | 1.22 |
| RI3 | 2.3 | 0.3 |
| α | 0.71 | 0.19 |
| β | 0.244 | 0.04 |
| δ | 0.123 | 0.95 |

shows the influence of measurement errors, in which the five angle parameters have been varied by ±2 degrees in each case independently of one another, while the rest were kept constant.

As can be seen in Table 1, the value RI3 is the most critical value of all the parameters.

However, as can also be seen from Table 1, the errors vary within an acceptable range, compared with the methods according to the prior art (Sven-Johansson, Visser Technique), which do not take any account at all of pelvis tilt.

It is clear that suitable images can be produced not just by using X-ray beams. Other imaging methods are known from the prior art and could likewise be used here. Furthermore, it is not absolutely essential to use a so-called C-arc. Other apparatuses can be used, in which the image-generating means and the image-recording means have a fixed arrangement with respect to one another. Furthermore, the body longitudinal axis of the patient does not need to match the longitudinal axis of a table on which the patient is lying while the images are being recorded. Any “misalignment” of the patient is taken into account by the pelvis rotation angle δ.

Therefore, what we claim is:

1. A method for determining an inclination angle RI and an anteversion angle RA of a patient's acetabulum in an anatomical reference system, an orientation of which is determined by the patient's pelvic bone, wherein tilt of the patient's pelvis is taken into consideration, the method comprising the steps of:
providing a first image of the pelvic bone wherein the first image represents a frontal plane XY including the pelvic bone;
determining a first inclination angle of the acetabulum using the first image;
determining a pelvis rotation angle δ which represents rotation angle of the pelvic bone about a normal Z of the frontal plane XY relative to an optimum patient location position;
providing a second image of the pelvic bone wherein a second image plane is rotated by an image rotation angle β relative to the frontal plane about a common section line of the two planes;
determining a second inclination angle of the acetabulum using the second image;
determining a pelvis-tilt angle α which represents a rotation of the frontal plane of the first image relative to an anterior-pelvic plane in the optimum patient location position;
setting up a linear equation system having at least two linear equations as a function of the previously determined angles;
expressing a normal vector no in polar coordinates of the anatomical reference system; and
solving the at least two linear equations for azimuth and polar angles of the normal vector n₀ for determining the inclination and the anteversion.

2. The method of claim 1, wherein the rotation of the second image plane by the image rotation angle β relative to the frontal plane is performed about the patient's longitudinal body axis.

3. The method of claim 1, wherein the equation system corresponds to a linear image A which maps the normal vector no of the acetabulum opening plane onto a zero vector of the anatomical reference system, namely by:
$$( \begin{matrix}0 \\ 0 \\ 0\end{matrix} ) = ( \begin{matrix}a 11 & a 12 & a 13 \\ a 21 & a 22 & a 23 \\ 0 & 0 & 0\end{matrix} ) ( \begin{matrix}{n}_{x} \\ {n}_{y} \\ {n}_{z}\end{matrix} ) = A \cdot {{n}_{0}}^{->}$$
wherein n₀ represents the normal vector of the acetabulum opening plane, and matrix elements aᵢⱼ are determined by the previously determined angles.

4. The method of claim 3, wherein as an alternative to the step of solving the at least two linear equations for the azimuth and polar angles of the normal vector n₀, the azimuth and the polar angles of the normal vector n₀ are determined by determining an eigenvector of the image A for eigenvalue of zero.

5. The method of claim 1, wherein a first equation of the linear equations represents a rotation of the acetabulum by the pelvis-tilt angle α and by the pelvis-rotation angle δ in order to represent the first inclination angle, and wherein a second equation of the linear equations represents a further rotation of the first equation by the image rotation angle β in order to represent the second inclination angle.

6. The method of claim 1, wherein the optimum patient location position is defined such that the anterior-pelvic plane is oriented parallel to the frontal plane, and a connecting line between acetabulum center points is oriented parallel to one of unit vectors x, which spans the frontal plane, wherein another unit vector y is oriented parallel to the patient's longitudinal body axis.

7. The method of claim 1, wherein the anatomical reference system is defined by the anterior-pelvic plane which, in turn, is defined by spinae at front iliac crest as well as symphysis of the pelvic bone.

8. The method of claim 1, wherein an imaging system is rotated about the patient's longitudinal body axis for producing the second image.

9. The method of claim 1, wherein the first and second inclination angles are each determined by means of a normal vector which is in each case perpendicular to an opening surface of the acetabulum as imaged in the first image and the second image, respectively.

10. The method of claim 9, wherein the respective normal vector is determined such that the acetabulum is approximated by an open hemisphere, wherein an opening edge of the respective hemisphere is approximated by an ellipse, major axes of which are determined, the respective normal vector being oriented orthogonally to the major axis.

11. The method of claim 10, wherein the first and second inclination angles are determined geometrically on the basis of the respective angle between the normal vector and a horizontal of the frontal plane.

12. The method of claim 1, wherein an origin of the frontal plane is located at a center point of the acetabulum.

13. The method of claim 1, wherein the images are provided by respective data sets.

14. The method of claim 1, wherein the images are provided by means of X-ray images or NMR.

15. The method of claim 1, wherein the pelvis rotation angle δ is determined geometrically as an angle between a horizontal of the frontal plane and either a connecting line between a center points of the acetabulum, or a connecting line between lowest edge points of the pubic bone.

16. The method claim 1, wherein the pelvis-tilt angle α is determined by using a pelvis balance.

17. The method of claim 1, wherein the images are provided using an imaging system which has a radiation source and a detection device, which are arranged rigidly with respect to one another and are rotatable about the patient's longitudinal body axis.

18. The method of claim 17, wherein the imaging system includes a C-arc.
